(19) United States
(12) Patent Application Publication
(10) Pub. No.: US 2020/0134450 A1
(43) Pub. Date: Apr. 30, 2020

(54) PREDICTING STORAGE NEED IN A DISTRIBUTED NETWORK

(71) Applicant: Shopfulfill IP LLC, Spring Valley, NY (US)

(72) Inventor: Shlomo Chopp, Spring Valley, NY (US)

(73) Assignee: Shopfulfill IP LLC, Spring Valley, NY (US)

(21) Appl. No.: 16/579,516

(22) Filed: Sep. 23, 2019

Related U.S. Application Data
(63) Continuation-in-part of application No. 15/935,041, filed on Mar. 25, 2018.
(60) Provisional application No. 62/476,801, filed on Mar. 26, 2017.
(60) Provisional application No. 62/744,392, filed on Oct. 11, 2018.
(60) Provisional application No. 62/735,134, filed on Sep. 23, 2018.

(51) Int. Cl. G06N 3/08; H04L 29/08; G06N 3/04

(52) U.S. Cl. CPC G06N 3/08; G06N 3/04; H04L 67/1097; H04L 67/22

(57) ABSTRACT

Systems and methods are disclosed for predicting storage need for an acquisition system within a distributed data storage network. An example method may include receiving, from a distributed storage network, node data associated with multiple nodes on the distributed storage network; receiving, from a first node in the distributed storage network, first user data associated with one or more acquisitions at a non-mobile platform; receiving, from a second node in the distributed storage network, second user data associated with one or more acquisitions at a mobile platform; determining, using the node data, first user data, and second user data, an estimated future storage need for each of the multiple nodes; generating a data transition scheme based on the estimated future storage needs; and implementing the data transition scheme into the distributed storage network.

### FIELD OF THE INVENTION

This application relates to a distributed data network. More specifically, systems and methods are disclosed for predicting storage need for an acquisition system within a distributed data storage network.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Systems and methods are disclosed for predicting storage need for an acquisition system within a distributed data storage network. In an embodiment, a system is disclosed. The system may include, for example, one or more data processors; and a non transitory computer readable storage medium containing instructions which when executed on the one or more data processors, cause the one or more processors to perform operations including: receiving, from a distributed storage network, node data associated with multiple nodes on the distributed storage network, wherein the node data includes data corresponding to characteristics of the multiple nodes and users that interact with the multiple nodes; receiving, from a first node in the distributed storage network, first user data associated with one or more acquisitions at a non-mobile platform, wherein the first user data includes data corresponding to the acquisition at the non-mobile platform and an associated physical action taken by a first user; receiving, from a second node in the distributed storage network, second user data associated with one or more acquisitions at a mobile platform, wherein the second user data includes data corresponding to the acquisition at the mobile platform and an associated action taken by a second user interacting with a mobile device; determining, using the node data, first user data, and second user data, an estimated future storage need for each of the multiple nodes; generating a data transition scheme based on the estimated future storage needs; and implementing the data transition scheme into the distributed storage network, wherein implementing the data transition scheme includes re-routing one or more item deliveries from the first node to the second node.

In another aspect, determining the estimated future storage need for each of the multiple nodes includes training and implementing an artificial neural network, wherein the node data, first user data, and second user data are inputs to the artificial neural network after the artificial neural network is trained. In another aspect, instructions may further include accessing a set of parameters for the artificial neural network, wherein the set of parameters includes weights associated with artificial neurons within the artificial neural network, and wherein the parameters are associated with the characteristics. In another aspect, the first user data and second user data are parsed into mobile-specific data, non-mobile-specific data, and hybrid data, and wherein data within the first user data and the second user data are tagged according to the parsing. In another aspect, the parsed mobile-specific data, non-mobile-specific data, and hybrid data are weighted based on the tagging, and wherein the weighted mobile-specific data, non-mobile-specific data, and hybrid data are analyzed to determine the data transition scheme. In another aspect, the data transition scheme includes amounts of data for transition, timing of transition, and method of transport for transition for each transition of data. In another aspect, the estimated future storage need for each of the multiple nodes includes an estimated number of items, a recommended number of items, and a confidence metric associated with the estimated number of items. In another aspect, the node data includes data specific to a geographic area around each node corresponding to the node data. In another aspect, the first user data associated with one or more acquisitions at a non-mobile platform is continuously captured via sensors located at the non-mobile platform. In another aspect, the data transition scheme is continuously updated based on new data from the sensors, and wherein the continuously updated data transition scheme causes periodic re-routing at predetermined times between nodes in the distributed storage network.

In an embodiment, a method is disclosed. The method may include, for example, receiving, from a distributed storage network, node data associated with multiple nodes on the distributed storage network, wherein the node data includes data corresponding to characteristics of the multiple nodes and users that interact with the multiple nodes; receiving, from a first node in the distributed storage network, first user data associated with one or more acquisitions at a non-mobile platform, wherein the first user data includes data corresponding to the acquisition at the non-mobile platform and an associated physical action taken by a first user; receiving, from a second node in the distributed storage network, second user data associated with one or more acquisitions at a mobile platform, wherein the second user data includes data corresponding to the acquisition at the mobile platform and an associated action taken by a second user interacting with a mobile device; determining, using the node data, first user data, and second user data, an estimated future storage need for each of the multiple nodes; generating a data transition scheme based on the estimated future storage needs; and implementing the data transition scheme into the distributed storage network, wherein implementing the data transition scheme includes re-routing one or more item deliveries from the first node to the second node.

In another aspect, determining the estimated future storage need for each of the multiple nodes includes training and implementing an artificial neural network, wherein the node data, first user data, and second user data are inputs to the artificial neural network after the artificial neural network is trained. In another aspect, the method may further include accessing a set of parameters for the artificial neural network, wherein the set of parameters includes weights associated with artificial neurons within the artificial neural network, and wherein the parameters are associated with the characteristics. In another aspect, the first user data and second user data are parsed into mobile-specific data, non-mobile-specific data, and hybrid data, and wherein data within the first user data and the second user data are tagged according to the parsing. In another aspect, the parsed mobile-specific data, non-mobile-specific data, and hybrid data are weighted based on the tagging, and wherein the weighted mobile-specific data, non-mobile-specific data, and hybrid data are analyzed to determine the data transition scheme. In another aspect, the data transition scheme includes amounts of data for transition, timing of transition, and method of transport for transition for each transition of data. In another aspect, the estimated future storage need for each of the multiple nodes includes an estimated number of items, a recommended number of items, and a confidence metric associated with the estimated number of items. In another aspect, the node data includes data specific to a geographic area around each node corresponding to the node data. In another aspect, the first user data associated with one or more acquisitions at a non-mobile platform is continuously captured via sensors located at the non-mobile platform. In another aspect, the data transition scheme is continuously updated based on new data from the sensors, and wherein the continuously updated data transition scheme causes periodic re-routing at predetermined times between nodes in the distributed storage network.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

A further understanding of the nature and advantages of various embodiments may be realized by reference to the following figures. The features and components of the figures are illustrated to emphasize the general principles of the present disclosure. In the appended figures, similar components or features may have the same reference label. Further, various components of the same type may be distinguished by following the reference label with a dash and a second label that distinguishes among the similar components. If only the first reference label is used in the specification, the description is applicable to any one of the similar components having the same first reference label irrespective of the second reference label.

FIG. 1 illustrates a block diagram of a distributed storage network, according to example embodiments of the present technology.

FIG. 2 illustrates a block diagram of a distributed storage network including a portion of the distributed storage network from FIG. 1, according to example embodiments of the present technology.

FIG. 3 illustrates a storage node according to some embodiments of the present technology.

FIG. 4 shows a block diagram of a system for generating storage predictions for distributed storage nodes, according to example embodiments of the present technology.

FIG. 5A shows a diagram of an artificial neural network, according to example embodiments of the present technology.

FIG. 5B an example set of variables for an artificial neural network, according to example embodiments of the present technology.

FIG. 6 illustrates a block diagram of a system 600 for predicting node-specific supply levels based on collected node and user data, according to embodiments of the present technology.

FIG. 7 illustrates a flow diagram including an example process for predicting storage need for an acquisition system, according to example embodiments of the present technology.

### DETAILED DESCRIPTION

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

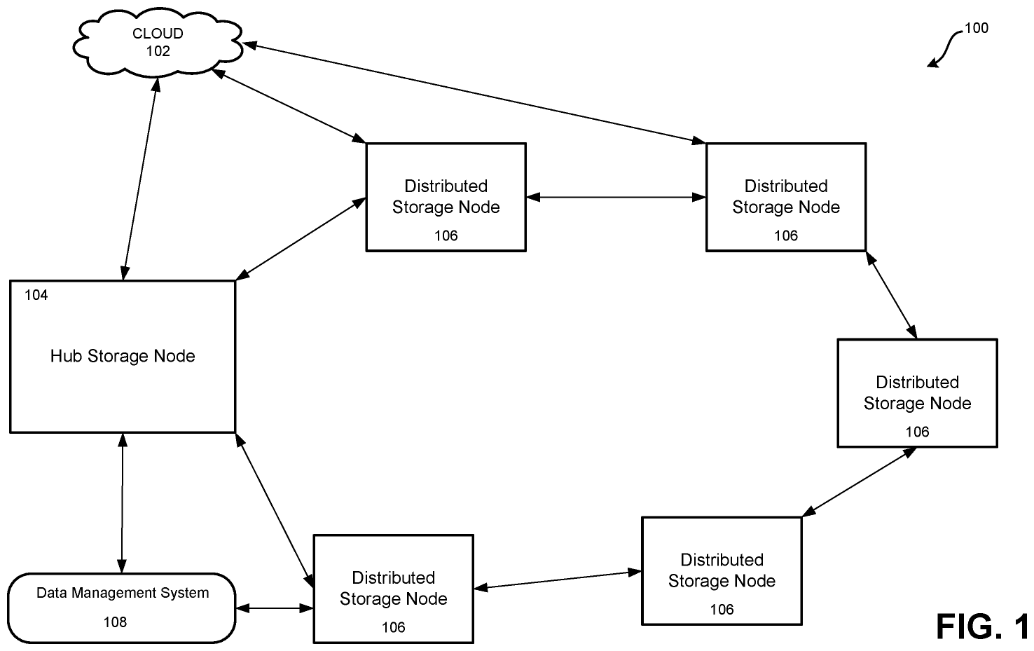

FIG. 1 illustrates a block diagram of a distributed storage network 100, according to example embodiments of the present technology. Distributed storage network 100 may include a variety of interconnected devices, including one or more distributed storage nodes 106, a hub storage node 104, and/or a data management system 108. Distributed storage network 100 may be structured as a distributed database, or may be structured as a computer network. Distributed storage nodes 106 may include one or more machines where information is stored on those nodes.

Distributed storage nodes 106 may each store separate information, may include overlapping information, or may include information that is replicated from node to node. If distributed storage nodes 106 include different data, each of the distributed storage nodes 106 may be responsible for receiving data associated with that specific node, devices that may be connected to that specific node, devices in a particular geographic region, users that interact with that specific node, or other setups. In some embodiments, a node may also be responsible for receiving data associated with a different node or a different geographic region. For example, this situation may occur if a neighboring node is not functioning, or for other reasons. Alternatively, each of the distributed storage nodes 106 may include different data, and the data that each node of the distributed storage nodes 106 stores may be related to other factors, such as decisions made by the distributed storage nodes 106, by data management system 108, by a user of the distributed storage network 100, or other factors. If distributed storage nodes 106 include the same or substantially the same data (e.g., if the nodes include replicated data), then each of the distributed storage nodes 106 may receive new data for storage, and may thereafter share the new data with the other nodes so that they may update their stored set of replicated data. Therefore, even if the set of distributed storage nodes 106 are structured to store replicated data, there may be certain periods of time where the replicated data is not perfectly replicated between the nodes, such as directly after a node receives new data but before that node shares the new data with the other nodes.

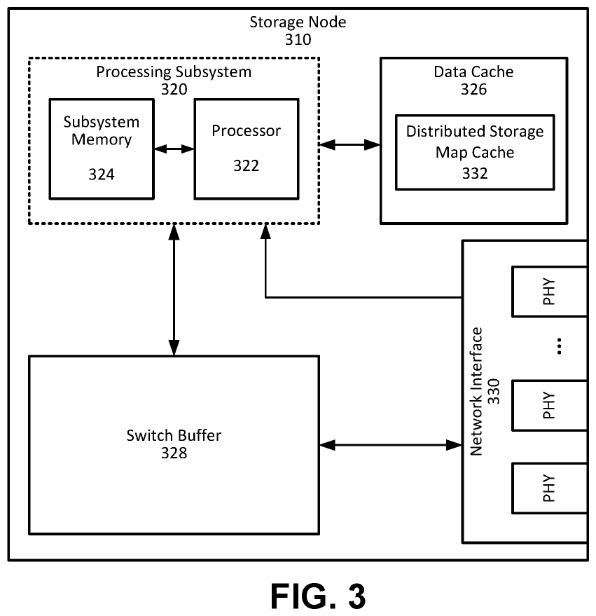

Hub storage node 104 may be connected to the distributed storage nodes 106 similar to how the distributed storage nodes 106 are connected to each other. Hub storage node 104 may be the same type of device or devices as one or more of the distributed storage nodes 106, and may include similar storage capacities and other similar characteristics. Alternatively, hub storage node 104 may be configured to be a central hub, which may include a greater quantity of storage space than the distributed storage nodes 106. For example, hub storage node 104 may control a variety of different components or characteristics of the distributed storage network 100. For example, hub storage node 104 may control the amount of data that is stored at itself and each distributed storage node 106, how data is distributed between the distributed storage nodes 106 (and between itself and the distributed storage nodes 106), how and when data is transferred between the distributed storage nodes 106 (and between itself and the distributed storage nodes 106), etc. Hub storage node 104 may store its own data separate from the distributed storage nodes 106, or may also serve as a central hub that stores all data separately stored at any of the distributed storage nodes 106 so that the distributed storage network 100 includes at least two copies of all data in the network. Storage node 104 may also be configured to function differently, and not be the same as a storage node 106 or a hub node. For example, storage node 104 may also be configured to be or include a device programmed to have a specific purpose different than being a distributed storage node 106 or a hub. For example, node 104 may be specifically configured to collect or process data directed to a more specific geographic area, for a certain type of data, or in a specific way. More extensive details regarding an example storage node, such as distributed storage nodes 106 or hub storage node 104, is described herein with respect to FIG. 3.

Hub storage node 104 may also function similar to or the same as a distributed storage node 106 when hub storage node 104 is considered with respect to other hub storage nodes 104 across a larger geographic area. For example, although only one hub storage node 104 is shown in FIG. 1, multiple hub storage nodes 104 may be present in distributed storage network 100 or in other distributed storage networks connected to distributed storage network 100. For example, while distributed storage network 100 may be located in one geographic area, other distributed storage networks may be located in other geographic areas and connected to distributed storage network 100. The other distributed storage networks may be a replica of distributed storage network 100 or may be different with different combinations of nodes and locations of nodes. In such embodiments, hub storage node 104 may be interconnected with other hub storage nodes 104 in nearby or other geographic areas, and its relationship to the other hub storage nodes 104 may be similar to a higher-level network of distributed storage nodes 106.

Hub storage node 104 may, in some embodiments, serve as another distributed storage node 106, or may include the control features described above. When hub storage node 104 serves as a distributed storage node and not as a control device, a separate device connected to the distributed storage network 100, such as data management system 108, may perform those control features. In some embodiments, any node of the distributed storage nodes 106 may serve as a control device that controls the characteristics and distribution of data within the network. In such embodiments, the hub storage node 104 and distributed storage nodes 106 may act as a mesh network of distributed storage nodes where each node in the network cooperates, shares data, etc. without a rigid hierarchical structure. In some embodiments, hub storage node 104 may include an entire another distributed storage network 100 as described herein. For example, a distributed storage network within storage node 104 may operate on a more specific or lower level, either geographically or with respect to the data it collects, among other possibilities. In some embodiments, the hub storage node in the distributed storage network within storage node 104 may include even another distributed storage network, and so on.

Distributed storage network 100 may also include a cloud network 102. Cloud network 102 may act as an additional, external storage space for storing extra, or copies of, data collected on the network. Cloud 102 may also perform processing tasks, such as the control processing tasks described herein. Any of the features (e.g., processing tasks, storage capabilities, etc.) of hub storage node 104 and distributed storage nodes 106 may be performed on the cloud 102, and any features of cloud 102 may be performed on hub storage node 104 or on one or more of the distributed storage nodes 106. In some embodiments, cloud network 102 may also include an entirely different, but related or connected, distributed storage network similar to distributed storage network 100.

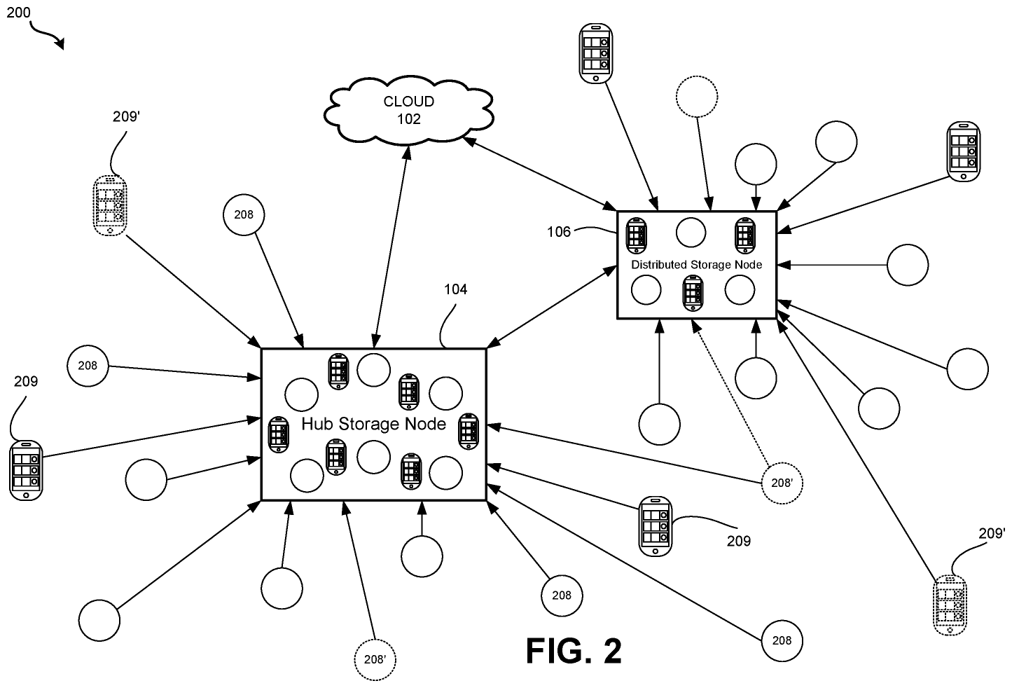

FIG. 2 illustrates a block diagram of a distributed storage network 200 including a portion of distributed storage network 100, according to example embodiments of the present technology. Distributed storage network 200 may include a cloud network 102, a hub storage node 104, and a distributed storage node 106. Although distributed storage network 200 is shown in FIG. 2 as including only one of each of the cloud network 102, hub storage node 104, and distributed storage node 106, distributed storage network 200 may include multiple cloud networks 102, multiple hub storage nodes 104, and multiple distributed storage nodes 106. Cloud network 102, a hub storage node 104, and a distributed storage node 106 may be the same as, or include similar features to, the cloud network 102, a hub storage node 104, and a distributed storage node 106 shown and described with respect to FIG. 1.

Devices and networks within distributed storage network 200 may receive, collect, and/or store data. Data may be collected from various sources. For example, data may be collected from various sources within one or more nodes within the distributed storage network 200. More specifically, data may be collected from an acquisition system that exists within the distributed storage network 200. The acquisition system may include, for example, one or more non-mobile acquisition platforms (e.g., where data may be collected as “non-mobile platform data) and one or more mobile acquisition platforms (e.g., where data may be collected as “mobile platform data). Non-mobile platform data may be collected, for example, from users 208 or on-site user devices interacting with a node on the distributed storage network 200, such as in a non-mobile platform. In some embodiments, hub storage node 104 and/or distributed storage node 106 may not be a single device, but may instead be a non-mobile acquisition platform (which may include, for example, showrooms, item storage area(s), etc.). In such embodiments, users 208 (e.g., customers) may arrive at and interact with hub storage node 104 or distributed storage node 106. For example, users may interact with items located in the non-mobile acquisition platform, test items in the non-mobile acquisition platform, acquire items in the non-mobile acquisition platform, etc. Data may be collected due to actions taken by the user when interacting with items in the non-mobile acquisition platform, or by interacting with devices in the non-mobile acquisition platform, such as a user device, an non-mobile acquisition platform device, point-of-sale device, etc. The node, or non-mobile acquisition platform, may include one or more sensors configured to observe user actions and collect data about those users.

Mobile platform data may be collected, for example, from off-site user devices 209 connected to one or more mobile acquisition platforms. The mobile acquisition platform and non-mobile acquisition platforms may be interconnected in that they may provide some or all of the same items for acquisition, may be a part of the same entity, owned and/or controlled by the same entity, etc. For example, a non-mobile platform may include a store and an associated mobile platform may include an ecommerce website with the same or similar branding as the store or item sold therein and interconnected as different aspects of the same or associated business or entity. Off-site user devices 209 may include mobile devices (e.g., smart phone, tablet, etc.), computers (e.g., laptops), or any other device that may allow a user to connect to a mobile acquisition platform. The mobile acquisition platform may be associated with, for example, the on-site non-mobile platform represented by node 104 or node 106. In such embodiments, users (e.g., customers) may interact with a user device 209 in order to view, peruse, research, and/or acquire items from the mobile acquisition platform, such as a mobile acquisition platform associated with the non-mobile acquisition platform at node 104 or node 106. For example, users may interact with items located on a website, or mobile acquisition platform, associated with the acquisition system, acquire items in the mobile acquisition platform, etc. Data may be collected due to actions taken by the user when interacting with user device 209 including items in the acquisition system. Data may include user's browse history (e.g., chains of clicks from the user), items the user interacted with or acquired, information about the user (e.g., age, gender, job, socioeconomic situation, address/neighborhood, frequency of browsing and/or acquisitions at the acquisition system, etc.). Even though certain types of data or variables may be described herein with respect to mobile platform or non-mobile platform acquisition data, data associated with one may also be collected with the other, if applicable. For example, even though data may be described as a certain type of mobile platform acquisition data, that same or a similar type of data may also be collected as non-mobile platform acquisition data if collected on-site at an mobile acquisition platform, and vice versa. At the same time, certain types of data may be specific to mobile as opposed to non-mobile, or vice versa. For example, data associated with a user's physical interaction with an item may be specific to non-mobile data, and may not be a type of data that is possible to capture in non-mobile (e.g., when a user is interacting with a website on their home computer). In another example, mobile data may include data that is more expansive since it may span more items, since more items may be available online as opposed to in a non-mobile (e.g., in-person) platform setting.

A hub storage node 104 or a distributed storage node 106 as shown and described in FIG. 1 may include the components of both mobile and non-mobile platforms. For example, a distributed storage node 106 or a hub storage node 104 may include both on-site non-mobile components that might be normally included in a retail store, including products, storage rooms, etc., and it may also include mobile-components that might normally be included in an non-mobile platform, including servers, processors, one or more devices with a mobile application or an website, a fulfillment warehouse, etc.

Although users may interact with the acquisition system via a user device 209 that is located remote from the non-mobile acquisition platforms, a user may also interact with a user device 209 while the user is on-site at a non-mobile acquisition platform located at, for example, node 104 or 106. Therefore, a user may interact with a non-mobile acquisition platform and a mobile acquisition platform associated with the acquisition system simultaneously. Therefore, data associated with the user may be collected while the user is interacting with both platforms at the same time, and certain data may be considered both mobile platform data and non-mobile data at the same time. Furthermore, mobile platform data may be collected while the user is also interacting with the non-mobile acquisition platform, and vice versa, even if the data does not overlap between the two and may be characterized only as mobile platform data or non-mobile platform data.

Other types of data may also be collected and used as part of the acquisition system. For example, node-specific data (i.e., “node data”) that includes data associated with the node itself, and not necessarily any particular user of set of users (although, for example, in some embodiments, node data may include data associated with one or more users). For example, node data may include data associated with a non-mobile acquisition platform located at a certain node in the distributed storage network 200. Node data may include, for example, items available for acquisition at a node, interaction and acquisition data (e.g., interaction or sales data) associated with each available item, frequency of supply shipment for an available item, relationships or connections between items (e.g., built-in connections, or connections from features of the items that cause users to view or acquire items together, etc.), among others.

The block diagram of a distributed storage network 200 includes various example users 208 and user devices 209, each of which may interact with an acquisition system at a node within network 200. Even though certain numbers of example users 208 and user devices 209 are shown in FIG. 2 as being connected to the nodes in the network 200, any number of users 208 and user devices 209 may be connected to the acquisition system at any one, including more or fewer than shown in FIG. 2. Furthermore, as shown by users 208′ and user devices 209′, users and user devices may connect and disconnect from the network at any time, and randomly, based on the user's decisions (or connectivity or geo-locating or other preprogrammed actions in a user devices 209) regarding their interactions with the network and/or the acquisition system. Therefore, while certain data associated with users and nodes may be temporal in nature, the temporal aspect of the data may be different for each piece of data or each interaction by a user or user device.

As used herein, the receiving or collection of data from user devices 209 or from a user 208 may instead represent receiving orders from users on a mobile platform or a non-mobile platform, respectively, as used herein. As such, a storage node 104 and/or 106 may include the storage of items (e.g., inventory) instead of (or in addition to) data.

FIG. 3 illustrates a storage node 310 according to some embodiments of the present technology. Storage node 310 may be or include a device or non-mobile acquisition platform similar to those described with respect to FIG. 2, such as distributed storage node 106 or hub storage node 104. Storage node 310 may include a processing subsystem 320, one or more network interfaces 330, and an data cache 326. In some embodiments, storage node 310 may include a switch buffer 328 and a distributed storage map cache 332.

Processing subsystem 320 may be implemented as one or more integrated circuits (e.g., one or more processors and/or controllers 322) and/or one or more subsystem memories 324. Processing system 320 may control the operation of storage node 310. In some embodiments, processing subsystem 320 may execute programs and/or processes in response to program code or instructions, and may maintain multiple concurrently executing programs or processes. Some or all of the program code or instructions to be executed by the one or more processors/controllers 322 may be stored in processing subsystem 320 (e.g., subsystem memory 324). The one or more processors/controllers 322 may primarily be used to process and store network traffic (e.g., IP packets) received by storage node 310. Subsystem memory 324 may be implemented as non-volatile memory, volatile memory, other non-transitory storage medium, or a combination of media, and/or a combination thereof.

Network interface 330 may facilitate exchange of communications within an internal network (e.g., a local area network), an external network, and/or between an internal network and an external network. Each network interface 330 may be implemented using one or more physical layer interface components (e.g., PHYs). Each physical layer interface component may represent a physical port on storage node 310 and may be assigned to one or more logical ports. Physical layer interface components may provide an interface to a physical medium to transport network traffic data, and may be used to convert signals transporting the network traffic data from a physical transport medium protocol to packetized data that processor subsystem 320 may process, or vice versa. For example, a WiFi capable physical layer interface component may convert WiFi radio frequency signals adhering to IEEE 802.11 family standards into packetized data, and/or vice versa. Storage node 310 may also include one or more antenna and/or suitable radio circuitry coupled to one or more wireless physical layer interface components to facilitate wireless communications with other devices.

In some embodiments, storage node 310 may include switch buffer 328 to temporarily store packets converted by the physical layer interface components 330. In some embodiments, the packets temporarily stored in switch buffer 328 may be associated with transport service headers of the packets such as OSI layer 4 transport headers. Depending on the type of storage node that storage node 310 is, the packets may additionally be temporarily stored in switch buffer 328 with at least some portion of the packets' OSI layer 3 network headers, OSI layer 2 data link headers, and/or OSI layer 1 physical addressing headers.

In some embodiments, storage node 310 may include distributed storage map cache 332 to store information about the network topology of the distributed storage network that storage node 310 is connected to. The information stored in distributed storage map cache 332 may include information about other nodes on the distributed network, such as destination addresses, and network cost metrics for sending a packet along a particular network path. Distributed storage map cache 332 may be populated using routing and network discovery protocols. The information stored in distributed storage map cache 332 may be used by processor subsystem 320 to determine how to route received data to their intended destinations. For example, processor subsystem 320 may examine the destination address, and metrics in distributed storage map cache 332 to determine the destination that the packet should be sent to. The network cost metrics may be used to select the most effective path to route the packet to its intended destination. Processor subsystem 320 may then determine which PHY is connected to the destination, and send the packet from the switch buffer 328 out to the appropriate port and network interface to reach the destination.

In some embodiments, storage node 310 may also include data cache 326. Data cache 326 may store data received by storage node 310 that may be likely to be requested again in the near future. The data may be received in packets sent to storage node 310 from a data host (e.g., a server) that is hosting the requested data. For example, a computing device (e.g., a client or user device) connected to storage node 310 may send a request to storage node 310 to request data. In response to receiving this request, storage node 310 may forward the data packets containing the data to the computing device (e.g., with permission from an internal or external entity, such as a web server associated with a storage node (i.e., an non-mobile acquisition platform).

In some embodiments, if storage node 310 receives multiple requests for the same data, there may be a high likelihood that more requests for the same data may also occur. Rather than forwarding each subsequent request, storage node 310 may cache the data in data cache 326 such that subsequent requests may be serviced by storage node 310. Once the data is cached, each subsequent request for the data from a computing device may be serviced by storage node 310 by retrieving the data from data cache 326, and sending the retrieved data to the computing device. By eliminating the round trip delay of the communications between storage node 310 and the data host, the requested data may be provided to the computing device faster. Furthermore, data associated with need for that data may be monitored and collected, and the distributed data storage system may be able to determine how to most efficiently load balance data (or workloads) most effectively. In contrast to switch buffer 328, the data being stored in data cache 326 may be retained in data cache 326 for an extended period of time even after the data has been transmitted from storage node 310. Processing subsystem 320 may remove the headers of the packets transporting the data before storing the data in data cache 326.

Storage node 310 may take many different forms according to embodiments of the present technology. For example, storage node 310 may be implemented as a storage node, such as distributed storage node 106 or hub storage node 104, in a distributed system, such as distributed system 100 or 200. Alternatively, storage node 310 may represent a more physical implementation of storage within a network, such as storage of physical items at a physical location, such as a non-mobile acquisition platform as described herein. Furthermore, storage node 310 may represent a storage node similar to distributed storage node 106 or hub storage node 104 in distributed storage network 100, but also psychically located within a non-mobile acquisition platform as described herein.

As an example, referring back to FIG. 1, storage node 104 or 106 may include, for example, robots that move items around the non-mobile platform, such as in a storage room or warehouse associated with the non-mobile platform (the storage of items may also be used for an associated mobile-platform as well). These robots may therefore assist in the movement of inventory from one node to another node after a recommendation (as described in more depth below) has been determined. For example, the robots may collect the items for movement to another node and place them together in packaging (e.g., pallets), and may deposit the packages into trucks to implement the transition plan/scheme. The robots may also allow for users (e.g., shoppers in a non-mobile platform) to shop for items without a cart since the robots may collect items that they place in their cart electronically (e.g., on a software application or browser URL using a user mobile or network device).

A transition plan or scheme may include a high level map that includes a picture or illustration of how data or items should be transitioned throughout the network, from certain nodes to other nodes. In some embodiments, the scheme may include a list or other representation of transitions, including numbers of one or more items and their source and destination nodes. In some embodiments, the scheme may include a specific set of instructions (which, for example, may be transmitted to a computer, and optionally displayed on a GUI, within a node, truck, etc.) for a controller (e.g., a hub node) or specific drivers to implement the plan. The plan may also be configured to be executed by one or more computers, either within one or more robots or within one or more external devices that are controlling such robots, so that they may instruct and implement a plan for robotic implementation of the plan.

As noted, devices and networks within the distributed storage networks (e.g., distributed storage networks 100 and 200) may receive, collect, and/or store various data collected from various sources, including users interacting with the nodes on the distributed storage networks. Nodes within the distributed storage networks, such as a hub storage node 104 and/or distributed storage node 106, may be incorporated into a non-mobile acquisition platform within an acquisition system (which may include, for example, showrooms, item/product storage area(s), etc.). In such embodiments, users (e.g., customers) may interact with items, devices, sensors, etc. at a non-mobile acquisition platform. Data may be collected that reflects users' interactions with the non-mobile acquisition platform, such as at, for example, sensors within the non-mobile acquisition platform. Furthermore, users may interact with a mobile acquisition platform. The mobile acquisition platform may be related to the non-mobile acquisition platform, i.e. be part of the same acquisition system, in that the mobile and non-mobile platforms may be owned by the same person or company, or may otherwise be associated with each other. Therefore, the two platforms may include the same or overlapping available items, may share a common acquisition system (e.g., a point-of-sale system that is one and the same for both platforms), and may share the same supply amounts. For example, a user may visit a non-mobile acquisition platform (e.g., an in-person store) to acquire an item, or the user may visit a mobile acquisition platform (e.g., a website associated with the acquisition system) to acquire the item. Historically, a non-mobile acquisition platform (e.g., an in-person store) and a mobile acquisition platform (e.g., an e-commerce website) may have different sources of inventory (e.g., different warehouses). However, it may be more efficient for the non-mobile acquisition platform and the mobile acquisition platform to be combined such that the two platforms use the same pool of inventory. The mobile platform acquisition data and the non-mobile platform acquisition data, as well as other sources of data, may be used to determine, or predict, supply amounts for one or more particular nodes in the distributed storage network. Predicting supply amounts at the distributed nodes may help the acquisition system determine how to distribute additional supply amounts, generate scheduling for a transport system used to distribute that additional supply amount, and provide superior customer service to the users that want to acquire items from the mobile and non-mobile platforms.

As used herein, the word “supply” or phrase “supply amount” may be used to mean or interchangeably with “inventory” to describe, for example, the amount of an item or items available and/or stored for use with a mobile or non-mobile platform as described herein. Similarly, the phrases “supply level” or “supply amount level” as used herein may be used interchangeably or to mean “inventory level” as used herein.

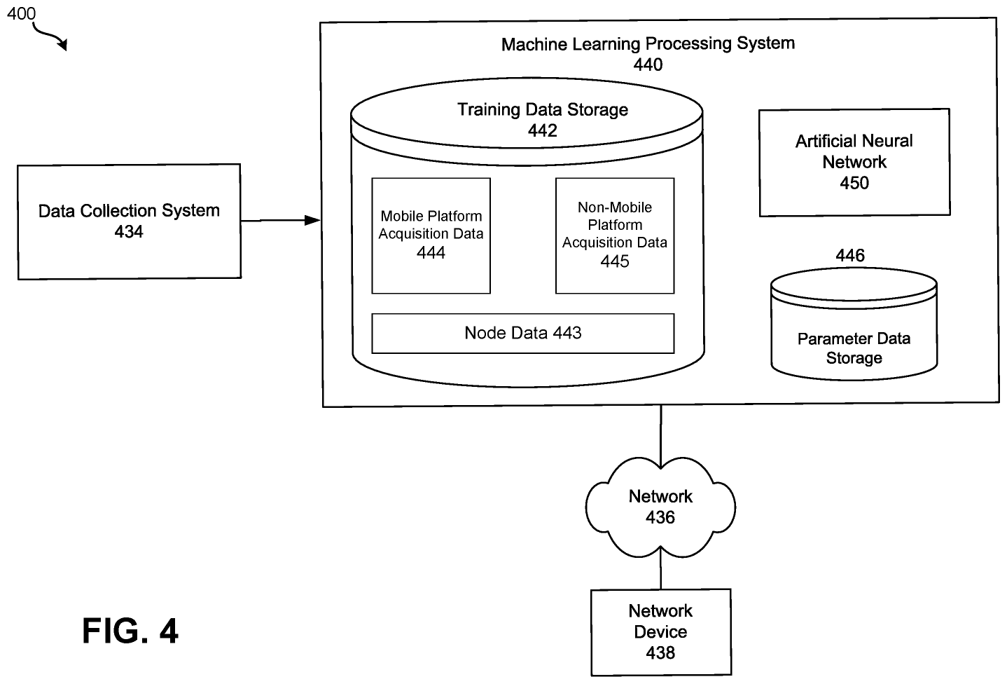

FIG. 4 shows a block diagram of a system 400 for generating storage (e.g., supply amount) predictions (i.e., prediction of demand, and/or recommendation of supply amount levels) for distributed storage nodes, according to example embodiments of the present technology. System 400 may include a machine learning processing system 440 and a data collection system 434. The data collection system may include sensors or other devices that collect data from a variety of sources. For example, the data collection system may include sensors or other data tracking devices or software that exist locally at a non-mobile acquisition platform or within a mobile acquisition platform. The machine learning processing system 440 may include one or more computers (not shown), each of which may include one or more processors (not shown) and/or transceivers (not shown) for communicating with the data collection system 434.

The machine learning processing system 440 may include training data storage 442, parameter data storage 446, and an artificial neural network 450. Some or all of the components shown to be within the machine learning processing system 440 may be located remotely, such as in a cloud network, such as cloud network 102. Further, some or all of the components shown to be located within machine learning processing system 440 may be located within the data collection system 434.

The training data storage 442 may include node data 443, mobile platform acquisition data 444, and non-mobile platform acquisition data 445. Mobile platform acquisition data 444 may include data associated with users that interact with a storage node via a mobile device or other mobile platform. Non-mobile platform acquisition data 445 may include data associated with users that interact with a storage node (e.g., a non-mobile acquisition platform) in real time, in person, etc. However, non-mobile platform acquisition data 445 may also include data associated with users that interact with a storage node via a mobile device or other mobile platform while the user is also interacting with the storage node in real time, in person, etc. Node data 443 may include data specific to a node or group of nodes, and not necessarily specific to a user or specific user's interactions with the node. For example, node data 443 may include historical data of user interactions and acquisitions at the node, or more general data regarding the node, such as location, address, geography, climate, temporal changes to acquisition data due to geographic area, etc.

The parameter data storage 446 may include a set of parameters that characterize the artificial neural network 450. As described in further detail below, the mobile platform acquisition data 444, the non-mobile platform acquisition data 445, node data 443, and the parameters may be used to train the artificial neural network 450. Once the artificial neural network 450 has been trained, the artificial neural network 450 may generate predictions for distributed storage nodes.

The data collection system 434 may include one or more sensors located at one or more distributed storage nodes, such as a distributed storage node 104 or a distributed storage node 106. Sensors may include video cameras or other data-capture sensors on-site at the associated non-mobile platform. Other data-capture sensors may include ultrasonic transducers, pressure sensors, accelerometers, infrared (IR) sensors, etc. However, sensors may not be necessary to collect certain types of data within data collection system 434. For example, the mobile or non-mobile platforms may collect acquisition data associated with available items over time. In another example, the mobile or non-mobile platforms may collect data associated with users and their habits. In another example, the mobile or non-mobile platforms may collect data associated with certain clicks by a user on an e-commerce website associated with the platform, such as when a user may place an item in their virtual cart, or when a user selects and peruses certain items. Data collection system 434 may be operated in various modes in order to acquire data associated with different users, nodes, etc. For example, the data collection system 434 may be used to acquire the mobile platform acquisition data 444 and the non-mobile platform acquisition data 445 that are stored in the training data storage 442.

The system 400 may also include a network device 438 that communicates with the machine learning processing system 440 via a network 436 (e.g., a cloud network, such as cloud network 102). The network device may access node data 443, mobile platform acquisition data 444, and non-mobile platform acquisition data 445 via the network 436 from the training data storage 442 or another training data storage that may be located in the cloud.

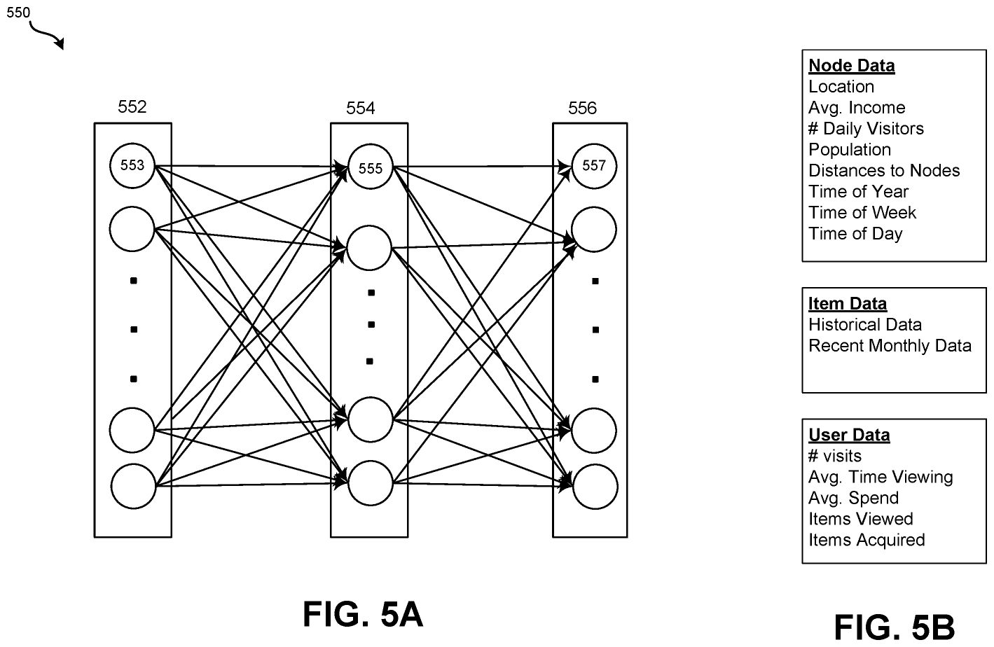

FIG. 5A shows a diagram of an artificial neural network 550, according to example embodiments of the present technology. Artificial neural network 550 includes an interconnected group of nodes, including a layer of input nodes 552, a layer of output nodes 556, and a layer of hidden nodes 554, where the nodes represent neurons. For example, artificial neural network 550 includes a layer of input nodes 552, which includes neurons 553. Input nodes 552 may include an input that the artificial neural network 550 may use to predict an output. Artificial neural network 550 may also include hidden layers, such as hidden layer 554, which includes neurons 555. Each of the hidden layers may include a plurality of artificial neurons 550. Although one hidden layer is shown, the artificial neural network 550 may include any number of hidden layers, including none (hidden layers are optional). The artificial neural network 550 also includes an output layer 552, which may include artificial neurons 557 that are represent a prediction as a result of applying the neural network to the input neurons. Any suitable number of output neurons may be used. For example, each output neuron may correspond to a prediction of demand (and/or a recommendation of resulting necessary supply amount) needed at a particular storage node as part of an acquisition system. The number of artificial neurons in each layer may be varied to yield the best results.

As discussed above, parameters of the artificial neural network 550, including weights of connections between the neurons within the hidden layer 554, are adjusted during the training of the artificial neural network. Parameters may include, for example, weights that should be applied to certain types of data in the training dataset. For example, if the input training dataset includes data associated with a particular item that is perceived to be more important to the functioning of the acquisition system, then parameter ranges may be set to be more conservative with the demand prediction and/or supply amount recommendation associated with that item. Similarly, that item may not be as important to a different node in a different location, and therefore a different item may be prioritized. Due to the number of different variables associated with the training dataset according to embodiments of the present technology, the parameters may be complicated. More specifically, different parameters may be provided that are specific to certain items, certain nodes, certain users, etc. An example set of variables are shown in FIG. 5B.

In order to use the neural network 550 to generate a prediction, such as a prediction of demand and/or recommendation for storage (e.g., supply amount) at a particular node, the neural network 550 may be trained. To train the neural network 550, a training dataset, such as from training data storage 442, may be accessed. As described with respect to FIG. 4, training data storage 442 may include different types of data that make up the training dataset. For example, the training dataset may include node data 443, mobile platform acquisition data 444, and non-mobile platform acquisition data 445. Mobile platform acquisition data 444 may include data associated with users that interact with a storage node, or a vendor that owns or runs the storage node non-mobile acquisition platform, via a mobile device or other mobile platform. Non-mobile platform acquisition data 445 may include data associated with users that interact with a storage node (e.g., an non-mobile acquisition platform) in real time, in person, etc. Node data 443 may include data specific to a node or group of nodes, and not necessarily specific to a user or specific user's interactions with the node. The training dataset may include, for example, historical node data 443, mobile platform acquisition data 444, and non-mobile platform acquisition data 445. More specifically, the training dataset may include data collected over a period of time that reflects user interactions with the acquisition system over that period of time. Furthermore, the training dataset may include other types of data, including but not limited to socioeconomic-related data related to socioeconomic factors, environmental-related data such as weather, political-related data, etc.

After the parameters and the training dataset, including node data, mobile platform acquisition data (e.g., first user data), and non-mobile platform acquisition data (e.g., second user data) have been accessed, the parameters and the training dataset may be used to train the neural network. After the neural network is trained, the trained neural network may be applied to a new set of data, such as real-time current data (e.g., third user data), to predict amounts of supply amount for specific nodes in the distributed storage network based on that current data. For example, the output layer 556 of neural network 550 may include one output, or may include multiple outputs. In some embodiments, the neural network is applied to a training dataset, and the output may include predicted supply amount levels for each node in the distributed storage network (i.e., for each of the non-mobile acquisition platforms in the network), or the outputs may go a step farther and recommend a conservative level of supply amount some percentage above the prediction for the system to implement as-is. In some embodiments, the output of the neural network will include a predicted supply amount (or a recommended supply amount level) for one or a group of specific nodes such that multiple trained neural networks would need to be applied to regional (geographic) or other grouped data to generate predictions (or recommendations) for each node across the distributed network).

Various variables may be used and defined as part of the training and/or application of the artificial neural network. An example set of variables is shown in FIG. 5B. For example, variables may include when data was captured, time of year, time of week, time of day, location of the node where the data was captured (for non-mobile data), geographic location of node (including, for example, average income of residents, number of daily visitors to non-mobile acquisition platform, distance from one node to another, among others. Also, various user-specific variables may be used, such as number of visits of the user to visit the vendor (both mobile and non-mobile, either together or separate), average time spent viewing items in general (or specific items), a user's footpath through a store or a click trail online, what items the user viewed, what brands of items the user viewed/acquired, what items the user put in the user's cart, what items the user ordered/acquired, what method of transportation the user selected to receive their acquired item (e.g., pick-up, delivery, robot or valet drop-off in the user's vehicle, etc.) and frequencies/predictions regarding the same, among others. Even though only certain variables are discussed herein, other variables are possible within the scope of the present technology.

Various different types of artificial neural networks may be used for artificial neural network 550 (and 450 in FIG. 4) according to embodiments of the present technology. For example, a feedforward artificial neural network may be used. In a feedforward neural network, connections between the nodes may not form a cycle. In other words, data moves forward through the neural network from input to output (via one or more hidden layers, if present) without being exposed to cycles or loops. In some embodiments, if a feedforward artificial neural network is used to determine a predicted or recommended supply amount level at a particular node, that prediction or recommendation may be used, along with that or a different trained neural network, to predict or recommend a supply amount level for a different (maybe related, such as nearby, or maybe not) node.

In some embodiments, a confidence metric may be determined and output along with the demand prediction and/or supply amount recommendation. The confidence metric may include a confidence level (e.g., a percentage of confidence) that the prediction/recommendation is accurate based on the input data and its relationship with the trained neural network.

In another example, another type of artificial neural network may be used. For example, an ensemble neural network/model may be used. In an ensemble neural network, multiple models are generated by the neural network, and then the models are combined to generate the desired output. For example, one model may be generated for each node in the distributed storage network, and then the models may be combined and work together to generate recommended supply amount projections.

In another example, a recurrent neural network may be used, such as, for example, a long short-term memory (LSTM) artificial neural network architecture. In a recurrent neural network, connections between nodes form a directed graph along a temporal sequence. For example, a recurrent neural network may be most helpful when input data includes temporal data. In the distributed storage network of some embodiments of the present technology, data may include temporal data. For example, data collected and stored in the distributed network may include may include data collected over time such that the system may be configured to compare acquisition, user, and/or node data over a period of time (e.g., from day to day, week to week, month to month, year to year, etc.). In another example, such as where extended temporal data exists, a convolutional neural network may be used.

In another example, various different types of unsupervised neural network structures may be used. For example, cluster analysis (i.e., clustering) may be used with different types of neural network algorithms. Clustering includes grouping a set of objects (e.g., geographically or otherwise similar nodes in a distributed network of non-mobile acquisition platforms) so that the objects in each node have similar characteristics, and are more similar to each other than to the objects in other clusters. Alternatively, or in addition to, clustering based on geographic location of nodes, data may be clustered based on mobile vs. non-mobile data. In other words, data generated and stored from non-mobile interactions (interactions with, for example, an non-mobile acquisition platform) may be clustered together in a cluster, and data generated and stored from mobile interactions (interactions with, for example, a related e-commerce website) may be clustered together in a different cluster.

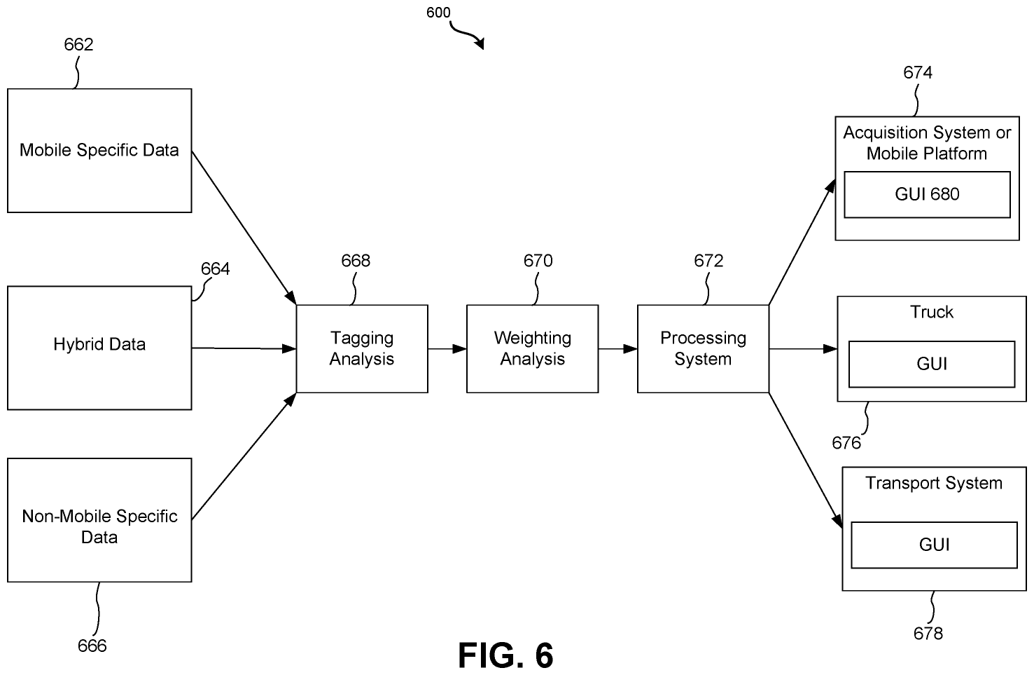

In some embodiments of the present invention, other processes that may not include a neural network or other types of machine learning are provided to generate a prediction or recommendation of node-specific supply amount levels. FIG. 6 illustrates a block diagram of a system 600 for predicting node-specific supply amount levels based on collected node and user data, according to embodiments of the present technology. System 600 may include, for example, retrieving various types of data. As noted, according to some embodiments of the present technology, various types of data may be collected by different nodes within a distributed storage network. The collected data may include data collected from a mobile acquisition platform and data collected from a non-mobile acquisition platform. The data may be individually tagged based on its source, so either tagged as having been acquired via the mobile acquisition platform or via the non-mobile acquisition platform. However, even though data may be tagged based on its source, the data may be parsed further to make the data more useful for determining a prediction or recommendation associated with supply amount at a certain node. Similar types of data, or sources of data, may be used as part of the embodiments described in FIG. 6 as with respect to the other embodiments described herein, and vice versa.

Within the set of data tagged as having the mobile acquisition platform as its source, certain data may be characterized as mobile-specific data 662 because that data is specific to the mobile platform. In other words, mobile-specific data 662 may have been collected at the mobile acquisition platform based on a characteristic of the mobile acquisition platform that is specific to the mobile acquisition platform and not shared by the non-mobile acquisition platform. An example of mobile-specific data may include data associated with a user's string of clicks when browsing items before adding an item to the user's cart, or taking other action, which may be specific to non-mobile platforms. However, such actions may be also taken in a non-mobile acquisition platform, such as when in-person at a non-mobile platform, using a client mobile device while in-person and interacting with a non-mobile platform (e.g., mobile device application, browser, etc.).

Similarly, within the set of data tagged as having the non-mobile acquisition platform as its source, certain data may be characterized as non-mobile-specific data 666 because that data is specific to the non-mobile platform. In other words, non-mobile-specific data 666 may have been collected at the non-mobile acquisition platform based on a characteristic of the non-mobile acquisition platform that is specific to the non-mobile acquisition platform and not shared by the mobile acquisition platform. An example of non-mobile-specific may include data associated with a user touching or otherwise interacting with a physical item. Such an action may not be taken in a mobile acquisition platform since items are not physically present when a user is interacting with, for example, an e-commerce website.

On the other hand, both the mobile acquisition platform and the non-mobile acquisition platform also collect data that could be characterized as hybrid data 664, where that data is not specific to either the mobile acquisition platform or the non-mobile acquisition platform. An example of hybrid data may include data associated with items that a user acquires. Since data may be collected by the mobile acquisition platform and the non-mobile acquisition platform, as well as other data capture devices (e.g., sensors), the hybrid data may need to be identified after the data is acquired and collected.

This parsing operation may be performed by a processor after receiving instructions from a software application to execute a particular algorithm. The algorithm may be configured to identify a portion of the collected data, to analyze the data to determine if the data is mobile specific, non-mobile specific, or hybrid, and then identify (e.g., via tagging) the data accordingly. To parse the data, the processor may perform operations including generating or retrieving keywords or other identifying characteristics that may cause certain data to be associated with mobile, non-mobile, or both platforms. In some embodiments, another operation may include, for example, analyzing the data to identify whether or not indications of physical actions taken by a user are included in the data. Since the types of physical actions associated with interaction with a mobile device are somewhat limited, or at least more limited than with a non-mobile platform, such physical interaction may indicate non-mobile specific data. If data is not identified as either mobile or non-mobile specific, then the data may be automatically identified as hybrid. On the other hand, specific operations may be taken to determine if certain data is hybrid data. For example, data acquired on the mobile platform may be compared to data acquired at the non-mobile platform, and data may be characterized and tagged as hybrid data if similar data exists in both sets of data. Similarity may be determined using, for example, certain keywords or thresholds. In some embodiments, the determination of how data is characterized may be learned using a machine learning algorithm, and the decisions may be dynamic and change over time. For example, certain data may initially be tagged as non-mobile platform data, but may later be changed to be tagged as hybrid data. This change may be due to certain corresponding data being available from the mobile platform, or for other reasons.

After the collected data is parsed, the data may be tagged, as noted, as part of tagging analysis 668. Alternatively, parsing and tagging the data may be performed as part of the same process by the processor. Tagging of the data may also be, in some embodiments of the present invention, optional and may not exist as part of the process.

In order to prepare the data for processing to determine a prediction of demand and/or recommendation for supply amount levels at specific nodes, the parsed data may be weighted. Weights assigned to the data may be performed based on groupings of data, or may be performed based on individual analysis of each individual piece of collected data. The weighting analysis 670 may also be performed in conjunction with parsing the data and/or tagging the data. Weighting analysis 670 may be performed in order to further identify which data should be given higher weight as compared to other data within each of the three parsed sets of data. For example, hybrid data 664 may be weighted higher than mobile or non-mobile specific data because having hybrid data from each of the two platforms may cause the data more valuable and/or accurate, and therefore may cause the data to be more helpful in generating a prediction or recommendation regarding future supply amount levels. Once the data is weighted appropriately based on the characteristics of the data, their source, etc., the processing system 672 (e.g., using a processor in the cloud such as cloud 102, or in one or more of the distributed nodes) may analyze the data to generate a prediction of future demand at specific nodes within the distributed network, and/or recommendations of supply amount levels at those nodes.

In some embodiments, an average of weights may be taken. For example, an action may have multiple cause possibilities, each of which may then be weighted to determine a likely cause. Then, a determination may be made whether a specific sub reason exists so as to give the action a heavier or lighter weight and the weight may be adjusted.

A prediction of demand for a certain item or set of items at one or more nodes in the distributed system, and an associated recommended supply amount level, may come in many forms. For example, they may be outputted as raw numbers. The numbers of items may be associated with a particular time period, or may be a consistent target for the system to meet at all times. In some embodiments, the prediction and recommendation may be presented as a percentage of overall inventory supply. For example, supply of a particular item may not be endless, and therefore the recommended supply amount levels may be directed to dividing up the supply amount across the nodes in a certain way. Predictions of demand may also help predict and affect ordering, manufacturing, and other aspects of supply chain needs. Other decisions may be affected as well, including on demand manufacturing and local vs cheaper sourcing for speedier replenishment.

In some embodiments, the recommendation may not include recommended levels of inventory, but may determine (e.g., calculate), based on current inventory levels at the different nodes, how certain numbers of items should be moved between nodes, and in what order. In other words, the processing system 672 may generate a transition plan or scheme based on the estimated future storage/inventory needs. The transition scheme may include specific truck routes, timing of truck routes, specific trucks assigned to certain routes based on size of trucks, and other specific information that may generate efficiencies for the transport system fleet and organization. For example, the updated transition scheme (for example, if a previous transition scheme was updated based on the new data and new analysis of that data) may cause additional acquisitions to take place based on efficient location of inventory, i.e. that inventory was at locations (e.g., local non-mobile acquisition platforms) where demand was high, and not at locations where demand was not as high and where the item may not have been sold. In other words, the processing system 672 may determine a set of probabilities for each item (e.g., for each piece of inventory of that item) to be sold at each node. Those probabilities may then be combined to determine how inventory should be moved between nodes to maximize the overall chances that inventory will be purchased, and in turn that customers will be satisfied.

Once the demand prediction and/or recommended inventory levels (or other outputs as described above) have been determined, the predictions and/or recommendations may be transmitted to certain portions of the distributed network and used to implement specific changes to the functioning of the network. For example, the output of the processing system 672 may be transmitted to one or more non-mobile acquisition platforms or mobile platform 674 (e.g., nodes in the distributed network, or e-commerce hub), and may be displayed on a GUI 680. That information may be analyzed in real time, and may cause adjustment of truck routes in real time. In some embodiments, the output of the processing system 672 may be transmitted directly to one or more trucks 676, such as to a GUI in the truck 676. Transmitting information, such as a new truck or transition scheme may allow for truck drivers to adjust their routes in real time based on where certain inventory needs to go. In some embodiments, the data may be transmitted to the transport system hub located at a non-mobile acquisition platform. From there, command signals may be generated and transmitted to individuals or devices on the network for those individuals or devices to take action regarding the updated plan/scheme.

Determined recommended inventory levels may be implemented in other ways. For example, an optimum route for a vehicle (e.g., truck) may be determined based on the recommended inventory levels for each node in the network. The optimum route may be determined based on a variety of variables and weights. Some example variables may include amount of inventory to transport, which inventory to transport to which nodes, traffic, weather, driver availability, amount of time required to travel between certain routes, etc. Weights may be applied to the different variables or to certain (or all) nodes based on decisions made by the system (e.g., the hub) or controllers of the network. For example, if a particular node is top priority because it has been out of inventory of a certain item or type of item for a certain period of time, or for other reasons, that node may be weighted higher than other nodes. Such decisions may be made based on a variety of factors, such as potential loss of revenue, number of potential customers affected, size of geographic region affected, among other factors.

This application is related to U.S. non-provisional application Ser. No. 15/935,041 (“the '041 application”), which is incorporated herein by reference in its entirety for all purposes. This application is also related to U.S. provisional application Nos. 62/735,134 (“the '134 application”) and 62/744,392 (“the '392 application”), each of which is incorporated herein by reference in their entirety for all purposes. In the '041, '134, and '392 applications, certain elements of the described embodiments are described using different terminology, but may refer to the same or similar element as described herein. For example, the term “shopping system” as used in the '041, '134, and '392 applications may be the same as or similar to an “acquisition system,” a “non-mobile platform,” a “non-mobile acquisition platform,” “distributed storage node(s),” “hub storage node(s),” or similarly described elements as described herein. All components of the “shopping system” or “shopping fulfillment center” as described in the '041, '134, and '392 applications may also be used within the “acquisition system” or “non-mobile platform” as described herein. The terms “ecommerce” and “ecommerce shopping platform” as used in the '041, '134, and '392 applications may be the same as or similar to a “mobile platform,” “mobile acquisition platform,” or similarly described elements as described herein. A “facility” or “showroom” or other features of a shopping system as described or used in the '041, '134, and '392 applications may be the same as, similar to, or used within a distributed storage node (e.g., node 104 or 106) as used herein.

As used herein, the word “data” or a reference to an amount of data may be interpreted to used interchangeably with “inventory” (or “supply amount” or “supply amount level”) in some embodiments where the distributed storage network is a, for example, shopping (e.g., non-mobile platform/retail, and mobile platform/ecommerce) product/inventory network. Similarly, “data storage” or “storage of data” or similar phrases may be used to mean or used interchangeably with product storage or storage of product or similar phrases. In this way, since a hub storage node and/or distributed storage node may collect and combine data from both mobile and non-mobile platforms, a shopping system may also combine inventory from both retail and ecommerce platforms and house that inventory in one location (e.g., at a node in the network, or in other words in a physical shopping system). The word “item” as used herein may be used to mean or interchangeably with the word “product” referring to product from a vendor.

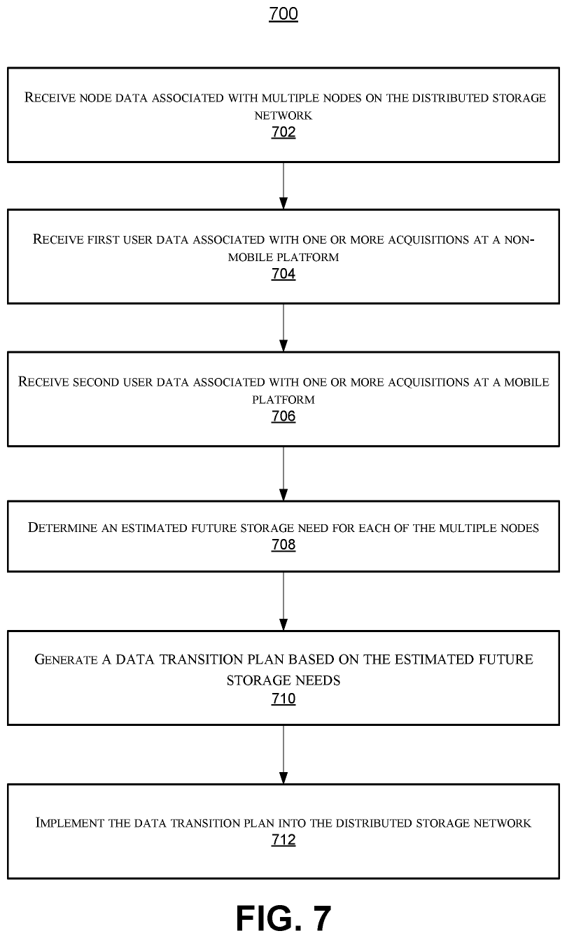

FIG. 7 illustrates a flow diagram including an example process for predicting storage (e.g., inventory) need for an acquisition system, according to example embodiments of the present technology. Step 702 may include, for example, receiving, from a distributed storage network, node data associated with multiple nodes on the distributed storage network. The node data may include data corresponding to characteristics of the multiple nodes and users that interact with the multiple nodes. Step 704 may include, for example, receiving, from a first node in the distributed storage network, first user data associated with one or more acquisitions at a non-mobile platform. The first user data may include data corresponding to the acquisition at the non-mobile platform and an associated physical action taken by a first user. Step 706 may include, for example, receiving, from a second node in the distributed storage network, second user data associated with one or more acquisitions at a mobile platform. The second user data may include data corresponding to the acquisition at the mobile platform and an associated action taken by a second user interacting with a mobile device. Step 708 may include, for example, determining, using the node data, first user data, and second user data, an estimated future storage need for each of the multiple nodes. Step 710 may include, for example, generating a data transition scheme based on the estimated future storage needs. Step 712 may include, for example, implementing the data transition scheme into the distributed storage network. Implementing the data transition scheme may include re-routing one or more item deliveries from the first node to the second node.

The above-described aspects are merely possible examples of implementations, merely set forth for a clear understanding of the principles of the present disclosure. Many variations and modifications may be made to the above-described example(s) without departing substantially from the spirit and principles of the present disclosure. All such modifications and variations are included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

A collection of exemplary examples, including at least some explicitly enumerated as “ECs” (Example Combinations), providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

EC 1. A system, comprising: one or more data processors; and a non transitory computer readable storage medium containing instructions which when executed on the one or more data processors, cause the one or more processors to perform operations including: receiving, from a distributed storage network, node data associated with multiple nodes on the distributed storage network, wherein the node data includes data corresponding to characteristics of the multiple nodes and users that interact with the multiple nodes; receiving, from a first node in the distributed storage network, first user data associated with one or more acquisitions at a non-mobile platform, wherein the first user data includes data corresponding to the acquisition at the non-mobile platform and an associated physical action taken by a first user; receiving, from a second node in the distributed storage network, second user data associated with one or more acquisitions at a mobile platform, wherein the second user data includes data corresponding to the acquisition at the mobile platform and an associated action taken by a second user interacting with a mobile device; determining, using the node data, first user data, and second user data, an estimated future storage need for each of the multiple nodes; generating a data transition scheme based on the estimated future storage needs; and implementing the data transition scheme into the distributed storage network, wherein implementing the data transition scheme includes re-routing one or more item deliveries from the first node to the second node.

EC 2. The system of any of the preceding or subsequent example combinations, wherein determining the estimated future storage need for each of the multiple nodes includes training and implementing an artificial neural network, wherein the node data, first user data, and second user data are inputs to the artificial neural network after the artificial neural network is trained.

EC 3. The system of any of the preceding or subsequent example combinations, further comprising operations including: accessing a set of parameters for the artificial neural network, wherein the set of parameters includes weights associated with artificial neurons within the artificial neural network, and wherein the parameters are associated with the characteristics.

EC 4. The system of any of the preceding or subsequent example combinations, wherein the first user data and second user data are parsed into mobile-specific data, non-mobile-specific data, and hybrid data, and wherein data within the first user data and the second user data are tagged according to the parsing.

EC 5. The system of any of the preceding or subsequent example combinations, wherein the parsed mobile-specific data, non-mobile-specific data, and hybrid data are weighted based on the tagging, and wherein the weighted mobile-specific data, non-mobile-specific data, and hybrid data are analyzed to determine the data transition scheme.

EC 6. The system of any of the preceding or subsequent example combinations, wherein the data transition scheme includes amounts of data for transition, timing of transition, and method of transport for transition for each transition of data.

EC 7. The system of any of the preceding or subsequent example combinations, wherein the estimated future storage need for each of the multiple nodes includes an estimated number of items, a recommended number of items, and a confidence metric associated with the estimated number of items.

EC 8. The system of any of the preceding or subsequent example combinations, wherein the node data includes data specific to a geographic area around each node corresponding to the node data.

EC 9. The system of any of the preceding or subsequent example combinations, wherein the first user data associated with one or more acquisitions at a non-mobile platform is continuously captured via sensors located at the non-mobile platform.

EC 10. The system of any of the preceding or subsequent example combinations, wherein the data transition scheme is continuously updated based on new data from the sensors, and wherein the continuously updated data transition scheme causes periodic re-routing at predetermined times between nodes in the distributed storage network.

EC 11. A method, comprising: receiving, from a distributed storage network, node data associated with multiple nodes on the distributed storage network, wherein the node data includes data corresponding to characteristics of the multiple nodes and users that interact with the multiple nodes; receiving, from a first node in the distributed storage network, first user data associated with one or more acquisitions at a non-mobile platform, wherein the first user data includes data corresponding to the acquisition at the non-mobile platform and an associated physical action taken by a first user; receiving, from a second node in the distributed storage network, second user data associated with one or more acquisitions at a mobile platform, wherein the second user data includes data corresponding to the acquisition at the mobile platform and an associated action taken by a second user interacting with a mobile device; determining, using the node data, first user data, and second user data, an estimated future storage need for each of the multiple nodes; generating a data transition scheme based on the estimated future storage needs; and implementing the data transition scheme into the distributed storage network, wherein implementing the data transition scheme includes re-routing one or more item deliveries from the first node to the second node.

EC 12. The method of any of the preceding or subsequent example combinations, wherein determining the estimated future storage need for each of the multiple nodes includes training and implementing an artificial neural network, wherein the node data, first user data, and second user data are inputs to the artificial neural network after the artificial neural network is trained.

EC 13. The method of any of the preceding or subsequent example combinations, further comprising: accessing a set of parameters for the artificial neural network, wherein the set of parameters includes weights associated with artificial neurons within the artificial neural network, and wherein the parameters are associated with the characteristics.

EC 14. The method of any of the preceding or subsequent example combinations, wherein the first user data and second user data are parsed into mobile-specific data, non-mobile-specific data, and hybrid data, and wherein data within the first user data and the second user data are tagged according to the parsing.

EC 15. The method of any of the preceding or subsequent example combinations, wherein the parsed mobile-specific data, non-mobile-specific data, and hybrid data are weighted based on the tagging, and wherein the weighted mobile-specific data, non-mobile-specific data, and hybrid data are analyzed to determine the data transition scheme.

EC 16. The method of any of the preceding or subsequent example combinations, wherein the data transition scheme includes amounts of data for transition, timing of transition, and method of transport for transition for each transition of data.

EC 17. The method of any of the preceding or subsequent example combinations, wherein the estimated future storage need for each of the multiple nodes includes an estimated number of items, a recommended number of items, and a confidence metric associated with the estimated number of items.

EC 18. The method of any of the preceding or subsequent example combinations, wherein the node data includes data specific to a geographic area around each node corresponding to the node data.

EC 19. The method of any of the preceding or subsequent example combinations, wherein the first user data associated with one or more acquisitions at a non-mobile platform is continuously captured via sensors located at the non-mobile platform.

EC 20. The method of any of the preceding or subsequent example combinations, wherein the data transition scheme is continuously updated based on new data from the sensors, and wherein the continuously updated data transition scheme causes periodic re-routing at predetermined times between nodes in the distributed storage network.

EC 21. A method, comprising: accessing, from a distributed storage network, node data associated with multiple nodes on the distributed storage network, wherein the node data includes data corresponding to characteristics of the multiple nodes and users that interact with the multiple nodes; receiving, from a first node connected to a distributed storage network, first user data associated with an acquisition at a non-mobile platform, wherein the first user data includes data corresponding to the acquisition at the non-mobile platform and an associated physical action taken by a first user; receiving, from a second node connected to the distributed storage network, second user data associated with one or more acquisitions at a mobile platform, wherein the second user data includes data corresponding to the acquisition at the mobile platform and an associated action taken by a second user interacting with a mobile device; accessing a set of parameters for an artificial neural network, wherein the set of parameters includes weights associated with artificial neurons within the artificial neural network; training the artificial neural network using the parameters, the first user data, the second user data, and the node data; receiving third user data; generating, using the trained artificial neural network, an artificial neural network output that includes an estimated future storage need associated with a particular node of the multiple nodes; outputting a data transition scheme based on the artificial neural network output; and implementing the data transition scheme, wherein implementing the data transition scheme includes re-routing one or more item deliveries from or to storage at the particular node of the multiple nodes.

EC 22. A system, comprising: one or more data processors; and a non transitory computer readable storage medium containing instructions which when executed on the one or more data processors, cause the one or more processors to perform operations including: accessing, from a distributed storage network, node data associated with multiple nodes on the distributed storage network, wherein the node data includes data corresponding to characteristics of the multiple nodes and users that interact with the multiple nodes; receiving, from a first node connected to a distributed storage network, first user data associated with an acquisition at a non-mobile platform, wherein the first user data includes data corresponding to the acquisition at the non-mobile platform and an associated physical action taken by a first user; receiving, from a second node connected to the distributed storage network, second user data associated with one or more acquisitions at a mobile platform, wherein the second user data includes data corresponding to the acquisition at the mobile platform and an associated action taken by a second user interacting with a mobile device; accessing a set of parameters for an artificial neural network, wherein the set of parameters includes weights associated with artificial neurons within the artificial neural network; training the artificial neural network using the parameters, the first user data, the second user data, and the node data; receiving third user data; generating, using the trained artificial neural network, an artificial neural network output that includes an estimated future storage need associated with a particular node of the multiple nodes; outputting a data transition scheme based on the artificial neural network output; and implementing the data transition scheme, wherein implementing the data transition scheme includes re-routing one or more item deliveries from or to storage at the particular node of the multiple nodes.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

That which is claimed is:

1. A system, comprising:
one or more data processors; and
a non transitory computer readable storage medium containing instructions which when executed on the one or more data processors, cause the one or more processors to perform operations including:
receiving, from a distributed storage network, node data associated with multiple nodes on the distributed storage network, wherein the node data includes data corresponding to characteristics of the multiple nodes and users that interact with the multiple nodes;
receiving, from a first node in the distributed storage network, first user data associated with one or more acquisitions at a non-mobile platform, wherein the first user data includes data corresponding to the acquisition at the non-mobile platform and an associated physical action taken by a first user;
receiving, from a second node in the distributed storage network, second user data associated with one or more acquisitions at a mobile platform, wherein the second user data includes data corresponding to the acquisition at the mobile platform and an associated action taken by a second user interacting with a mobile device;
determining, using the node data, first user data, and second user data, an estimated future storage need for each of the multiple nodes;
generating a data transition scheme based on the estimated future storage needs; and
implementing the data transition scheme into the distributed storage network, wherein implementing the data transition scheme includes re-routing one or more item deliveries from the first node to the second node.

2. The system of claim 1, wherein determining the estimated future storage need for each of the multiple nodes includes training and implementing an artificial neural network, wherein the node data, first user data, and second user data are inputs to the artificial neural network after the artificial neural network is trained.

3. The system of claim 2, further comprising operations including:
accessing a set of parameters for the artificial neural network, wherein the set of parameters includes weights associated with artificial neurons within the artificial neural network, and wherein the parameters are associated with the characteristics.

4. The system of claim 1, wherein the first user data and second user data are parsed into mobile-specific data, non-mobile-specific data, and hybrid data, and wherein data within the first user data and the second user data are tagged according to the parsing.

5. The system of claim 4, wherein the parsed mobile-specific data, non-mobile-specific data, and hybrid data are weighted based on the tagging, and wherein the weighted mobile-specific data, non-mobile-specific data, and hybrid data are analyzed to determine the data transition scheme.

6. The system of claim 1, wherein the data transition scheme includes amounts of data for transition, timing of transition, and method of transport for transition for each transition of data.

7. The system of claim 1, wherein the estimated future storage need for each of the multiple nodes includes an estimated number of items, a recommended number of items, and a confidence metric associated with the estimated number of items.

8. The system of claim 1, wherein the node data includes data specific to a geographic area around each node corresponding to the node data.

9. The system of claim 1, wherein the first user data associated with one or more acquisitions at a non-mobile platform is continuously captured via sensors located at the non-mobile platform.

10. The system of claim 9, wherein the data transition scheme is continuously updated based on new data from the sensors, and wherein the continuously updated data transition scheme causes periodic re-routing at predetermined times between nodes in the distributed storage network.

11. A method, comprising:
receiving, from a distributed storage network, node data associated with multiple nodes on the distributed storage network, wherein the node data includes data corresponding to characteristics of the multiple nodes and users that interact with the multiple nodes;
receiving, from a first node in the distributed storage network, first user data associated with one or more acquisitions at a non-mobile platform, wherein the first user data includes data corresponding to the acquisition at the non-mobile platform and an associated physical action taken by a first user;
receiving, from a second node in the distributed storage network, second user data associated with one or more acquisitions at a mobile platform, wherein the second user data includes data corresponding to the acquisition at the mobile platform and an associated action taken by a second user interacting with a mobile device;
determining, using the node data, first user data, and second user data, an estimated future storage need for each of the multiple nodes;
generating a data transition scheme based on the estimated future storage needs; and
implementing the data transition scheme into the distributed storage network, wherein implementing the data transition scheme includes re-routing one or more item deliveries from the first node to the second node.

12. The method of claim 11, wherein determining the estimated future storage need for each of the multiple nodes includes training and implementing an artificial neural network, wherein the node data, first user data, and second user data are inputs to the artificial neural network after the artificial neural network is trained.

13. The method of claim 12, further comprising:
accessing a set of parameters for the artificial neural network, wherein the set of parameters includes weights associated with artificial neurons within the artificial neural network, and wherein the parameters are associated with the characteristics.

14. The method of claim 11, wherein the first user data and second user data are parsed into mobile-specific data, non-mobile-specific data, and hybrid data, and wherein data within the first user data and the second user data are tagged according to the parsing.

15. The method of claim 14, wherein the parsed mobile-specific data, non-mobile-specific data, and hybrid data are weighted based on the tagging, and wherein the weighted mobile-specific data, non-mobile-specific data, and hybrid data are analyzed to determine the data transition scheme.

16. The method of claim 11, wherein the data transition scheme includes amounts of data for transition, timing of transition, and method of transport for transition for each transition of data.

17. The method of claim 11, wherein the estimated future storage need for each of the multiple nodes includes an estimated number of items, a recommended number of items, and a confidence metric associated with the estimated number of items.

18. The method of claim 11, wherein the node data includes data specific to a geographic area around each node corresponding to the node data.

19. The method of claim 11, wherein the first user data associated with one or more acquisitions at a non-mobile platform is continuously captured via sensors located at the non-mobile platform.

20. The method of claim 19, wherein the data transition scheme is continuously updated based on new data from the sensors, and wherein the continuously updated data transition scheme causes periodic re-routing at predetermined times between nodes in the distributed storage network.
